(19) United States
(12) Patent Application Publication
(10) Pub. No.: US 2022/0342946 A1
(43) Pub. Date: Oct. 27, 2022

(54) SYSTEMS AND METHODS OF IMPROVED ADVERTISING USING SYMBOLS AS CHARACTER INTERFACE

(71) Applicant: GBT Technologies Inc., Santa Monica, CA (US)

(72) Inventors: Danny Rittman, San Diego, CA (US); Mo Jacob, Beverly Hills, CA (US)

(21) Appl. No.: 17/723,658

(22) Filed: Apr. 19, 2022

Related U.S. Application Data
(60) Provisional application No. 63/177,669, filed on Apr. 21, 2021.

(51) Int. Cl. G06F 16/958; G06Q 30/02; G06F 3/04812; G06F 16/955

(52) U.S. Cl. CPC G06F 16/958; G06Q 30/0277; G06Q 30/0276; G06F 3/04812; G06F 16/9562

(57) ABSTRACT

Systems and methods of generating smart, non-obtrusive advertisements are provided that include scanning content displayed on a media page, dividing the content into a plurality of discrete sets of content, converting the discrete sets of content into one or more flipping pages accessible by a reader from the media page, assigning the advertising symbols to one or more locations in the flipping pages, and inserting the advertising symbols into the assigned locations within the flipping pages. The advertising symbols can be corporate logos, product logos, and/or brand names and may replace text or graphic characters in the content or may replace the mouse cursor. The flipping pages may include at least two sequential flipping pages, and the advertising symbols can be inserted between the two sequential flipping pages.

### CROSS-REFERENCE TO RELATED APPLICATION

This application is a non-provisional of and claims priority to U.S. patent application Ser. No. 63/177,669, filed Apr. 21, 2021, which is hereby incorporated by reference herein in its entirety.

### FIELD

The present disclosure relates to systems and methods of generating smart, unobtrusive advertisements in any typed or written media and/or Internet browser having a textual and graphical interface.

### BACKGROUND

Advertising is a necessary component of modern commerce. Conflicting issues are involved in advertising, for example, the advertiser wants to deliver a message to the consumer, so the attention of the consumer must be captured, but the advertiser must not present the advertisement in a way or to the extent that it hinders the reading/viewing activity of the consumer or annoys the consumer.

Advertising available in typed or written media like newspapers, magazines, publications, and the Internet usually use an entire section and/or a special allocation of the media page. The typical advertisement is done using graphical representation of the corporation or product and is used once or a few times in a media form. This is a minimal amount of exposure to the advertisement material. Another disadvantage described by Internet surfers (people who read Internet documents) is that typical advertisement banners and images are ignored due to their appearance and special graphics effects.

Ads and banners in newspapers, magazines, and Internet web sites are expensive due to the space issue. A page in a newspaper or magazine or any Internet based document is very limited for advertisement space. This causes higher priced advertisement banners and ads, and limits corporations and individuals from advertising within popular media forms like major newspapers, magazines and publications. Furthermore, Internet documents that are presented with special graphical effects may not be view by all Internet surfers due to compatibility issues. If a user is using an old version of an Internet browser, he or she may not be exposed to the advertisement material since it was made for the newest technology Internet browsers.

Currently available advertising methods on the Internet are very restrictive. An advertiser can only display “banner” ads, as explained earlier. This is due to the kind of interface currently available on computers. The Windows interface that derives from the “desktop” metaphor involves a presentation of a series of 2-dimensional “window” interfaces. On this kind of interface, advertisers either must contend with a small banner, which does not quite satisfy the need to deliver a message effectively to the consumers, or they have to enlarge the banner, which hinders the activities of the consumer and annoys the consumer. Therefore, the parameters of the advertisement are very limited and not necessarily effective.

Another current method of advertising on the Internet uses a pop-up window whenever the user enters a certain web page to view data. This type of pop-up window is ineffective for both the consumer and the advertiser. From the point of view of the consumer, pop-up windows are annoying, especially when they are big. From the point of view of the advertiser, pop-up windows are ineffective because, unlike the usual banner advertisements on the Web pages, they are not displayed long enough for the consumer to absorb the message. Many consumers simply close the pop-up window or move the desired Web contents into view and relegate the pop-up window to the background. Thus, the pop-up windows are commonly not viewed by the consumer for a significant period. Another problem with current browsers and browsing methods relates to their limited ability to identify, contact, and recruit advertisers that will be inserting advertisements into the displayed content.

A similar situation is found regarding the participants in the process of delivering newspaper/magazine content to consumers, except for the fact that magazine/newspaper publishers actively advertise for others both within and before/after the content. Once again, the entities that deliver the content display have almost no ability to insert advertisements.

With respect to the delivery of television/movie content to consumers, the entities that deliver the display have developed methods of inserting advertisements before the content. For example, movie theaters commonly insert advertisements for themselves and for local businesses prior to the showing of a film. Furthermore, the manufacturers of the display also insert advertisements prior to the start of a film. An example is the advertisements for “DOLBY SURROUND SOUND” commonly shown prior to commencement of the film. In these cases, the entities that deliver the content to the consumer have developed a limited ability to advertise before the delivery of the content.

Advertising in Internet data transmission has not yet been developed even to the extent known in the delivery of movie/television content displays. There are several entities that participate in delivery of the content to the consumer. A separate web host can maintain and/or update a memory containing the content under the direction of a web publisher. An Internet service provider can transmit the content data from the web host memory to a consumer's site. A browser producer can provide a browser that will decode and generate instructions for displaying the content data at the consumer's site. Finally, a monitor or other output device can display the content under the instructions of the browser.

The insertion of advertisements by each of these entities that deliver Internet content to the consumer is haphazard at best. For example, the web host is entirely unknown to an individual who is accessing content stored on the web host's computers. Internet service providers such as NETZERO place a banner advertisement across the top of the display screen. Thus, this banner is neither inserted into the actual content nor targeted to the content being accessed, and furthermore retains the aforementioned problems of banner advertisements. Monitor manufacturers only include a corporate logo located outside the content display area and generate no direct advertising revenue therefrom.

Advertisements recruited, selected, and displayed by a browser producer are likewise primitive. Both NETSCAPE® NAVIGATOR® and MICROSOFT® INTERNET EXPLORER® have limited advertisements to a title of the browser program and one or more corporate trademarks displayed at various locations on the browser window. This prohibits the browser producers from advertising for others than themselves, from inserting the advertisements within the displayed content, and from receiving revenue for the advertisement of various products made by others.

As a result, advertising is not fulfilling its maximum capability of exposure to viewers in the popular media. The interaction between a reader/browser and the printed advertisement material is not used in the most efficient way to provide the reader/browser with the necessary exposure.

Therefore, there is a need for improved systems and methods of generating smart, unobtrusive, advertisements. There also is a need for a novel advertising method and system for typed, printed, written and electronic media that can be integrated into Internet documents. Moreover, there is a need for a method to significantly increase the exposure to the advertisement material using special advertising symbols.

### SUMMARY

The present disclosure, in its many embodiments, alleviates to a great extent the disadvantages and problems associated with available schemes for delivering advertisements in popular media like newspapers, magazines, publications, movies, and the Internet by providing methods and systems to replace any desired symbol, text character, or graphic with an advertising symbol. By this mechanism, any corporation or other type of advertiser may advertise products and/or desired subjects.

Documents available on typed or written media like newspapers, magazines, publications, and the Internet are usually represented in the format of “hypertext.” Each hypertext “page” typically uses periods (dots), commas, and other symbolic characters representing the context. The same concept is used on the Internet for web browsers. Disclosed methods can replace those characters with advertising symbols.

Disclosed embodiments provide novel methods and systems for electronic and non-electronic advertising that is modeled after the traditional media. These involve inserting specials symbols of advertisements among the contents that are represented in media documents. The advertising symbols inserted in this manner do not obstruct or hinder the reading of the contents to an extent that will annoy the reader.

More particularly, the present disclosure describes methods, systems, and computer software for advertising using advertisement material as symbol characters. The present disclosure describes advertising methods, systems, and computer software for all types of media. Media may be newspapers, magazines, publications, software, mobile software, or any type of typed or written (textual and graphical based) material. The advertising method, system and computer software may be used on web sites using any Internet browser interface.

Exemplary methods of advertising are done by inserting advertising symbols in any desired place within the media page or pages. The advertising symbols may also replace typical text or graphic characters (ASCII format or any type of image format) in the media page or pages. An advertising symbol may be the advertiser's logo, product, a symbol, a brand name, or any other type of advertisement material. Advertising symbols may replace typical textual contents like periods, commas, or any other type of textual or graphical contents.

Advertising symbols may be inserted anywhere in the written material. The advertisements are presented as needed on the media or computer screen without obstructing the viewing and reading of other contents. While reading the written material the viewer is also reading the advertiser symbols and therefore is exposed to the advertisement. The same system may be implemented on web sites, software application or mobile software apps. Thus, disclosed automatic advertisement systems and methods are shared over global network, worldwide.

Desired text or graphical characters may be replaced with advertising symbols. The size of the advertising symbol may be the same as the written material font size or any other desirable size according to the media designer. Disclosed systems automatically insert the advertising symbols in the desired places or replace any desired textual character with the advertising symbol. The input is any text and graphical context in any standard format and produce an output with the advertising symbols.

Using the disclosed advertising methods and systems, as described herein, provides a novel method of inserting advertisements into content of all type of typed or written media as well as a novel method for revenue sharing among all the parties involved. The systems described can dynamically deliver and/or stream advertisements to users using any media form or internet browser. In addition, disclosed systems and methods can provide static advertisement delivery where advertisements are pre-delivered and incorporated into typed, printed, electronic or non-electronic content.

Exemplary systems include Artificial Intelligence algorithms for scanning a given text, identifying pre-defined words, and assigning advertisement icons near or instead of them. The AI engine is also capable of identifying pre-defined words in NLP (Natural Language Processing) and performs replacement and/or addition of advertisement icons in places.

Disclosed embodiments take advantage of the media textual and graphical interface to create a better advertisement viewing/reading experience for the user on the one hand and more effective delivery of advertisements for the advertiser on the other hand. At the same time, a novel advertisement matching and delivery model in connection with this interface becomes possible and suggests new advertisement methods for the content providers and advertisers, as well as methods for revenue sharing between the involved parties.

Advertising symbols inserted by the typed or printed media and Internet browser can lead to different revenue sharing models. Using the systems and methods described here in any media form may significantly increase the reader/browser exposure to the advertisement and therefore benefits the reader and the advertiser. This enables corporations and individuals to develop better revenue models.

An exemplary embodiment of a computer-implemented system of generating advertisements comprises a division module, a conversion module, and an insertion module. The division module divides content displayed on a media page into a plurality of discrete sets of content. The conversion module converts the plurality of discrete sets of content into one or more flipping pages accessible by a reader from the media page. The insertion module inserts one or more advertising symbols into one or more locations within the one or more flipping pages. The media page could be an electronic media page or a print media page. The advertising symbol could be a corporate logo, a product logo, and/or a brand name.

In exemplary embodiments, the one or more advertising symbols replace text or graphic characters in the plurality of discrete sets of content. The replaced text or graphics can be punctuation marks. The one or more advertising symbols also could replace a mouse cursor. In exemplary embodiments, the one or more flipping pages comprise at least two sequential flipping pages, and the insertion module inserts the one or more advertising symbols between two of the at least two sequential flipping pages. Exemplary systems further comprise an artificial intelligence unit, and the division module, the conversion module, and the insertion module are contained in or in communication with the artificial intelligence unit. The artificial intelligence unit may scan the content in the media page, identify pre-defined words, and assign one or more advertising symbols to one or more locations in the one or more flipping pages.

Exemplary computer-implemented methods of generating advertisements comprise scanning content displayed on a media page, dividing the content into a plurality of discrete sets of content, converting the plurality of discrete sets of content into one or more flipping pages accessible by a reader from the media page, assigning one or more advertising symbols to one or more locations in the one or more flipping pages, and inserting one or more advertising symbols into the one or more assigned locations within the flipping pages. The advertising symbols may be assigned based on pre-determined relevance criteria. In exemplary embodiments, the advertising symbols are inserted using an industry standard text and graphics document format. Some of the method steps may be performed using artificial intelligence. The content could be the credits of a show, a series, or a movie.

Exemplary embodiments further comprise displaying the one or more flipping pages having the one or more advertising symbols. The one or more flipping pages may comprise at least two sequential flipping pages, and the inserting step comprises inserting the one or more advertising symbols between two of the at least two sequential flipping pages. Disclosed methods include bookmarking one of the one or more advertising symbols. Exemplary methods further comprise simultaneously displaying at least two discrete sets of content on a single display. The one or more advertising symbols in a first of the at least two discrete sets of content may comprise a first advertising symbol or relate to a first advertiser. The one or more advertising symbols in a second of the at least two discrete sets of content may comprise a second advertising symbol or relate to a second advertiser.

Accordingly, it is seen that systems and methods of generating smart, unobtrusive advertisements are provided. These and other features of disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is an illustration of an exemplary embodiment of a system and method of generating advertisements in accordance with the present disclosure;

FIG. 2 is an illustration of an exemplary embodiment of a system and method of generating advertisements in accordance with the present disclosure;

FIG. 3 is an illustration of an exemplary embodiment of a system and method of generating advertisements in accordance with the present disclosure;

FIG. 4 is an illustration of an exemplary embodiment of a system and method of generating advertisements in accordance with the present disclosure;

FIG. 5 is a block diagram of an exemplary flipping pages creation process for a system and method of generating advertisements in accordance with the present disclosure;

FIG. 6 is an illustration of an exemplary embodiment of a mouse cursor advertisement for a system and method of generating advertisements in accordance with the present disclosure;

FIG. 7 is a front view of a mouse cursor advertisement interface for a system and method of generating advertisements in accordance with the present disclosure;

FIG. 8 is a front view of a mouse cursor advertisement interface for a system and method of generating advertisements in accordance with the present disclosure;

FIG. 9 is a block diagram showing an exemplary embodiment of a system and method of generating advertisements in accordance with the present disclosure;

FIG. 10 is a process flow diagram of an exemplary method of content processing for a system and method of generating advertisements in accordance with the present disclosure;

FIG. 11 is a block diagram showing an exemplary AI deep learning process flow for a system and method of generating advertisements in accordance with the present disclosure;

FIG. 12 is a process flow diagram showing an exemplary flipping pages and advertising symbols insertion flow for a system and method of generating advertisements in accordance with the present disclosure; and

FIG. 13 is a block diagram of an exemplary embodiment of the internal structure of a computer in which various embodiments of the disclosure may be implemented.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate with a wide variety of such parameters. It should be noted that the figures do not show every piece of equipment, nor the materials, configurations, and directions of the various circuits, units, modules, and communications systems.

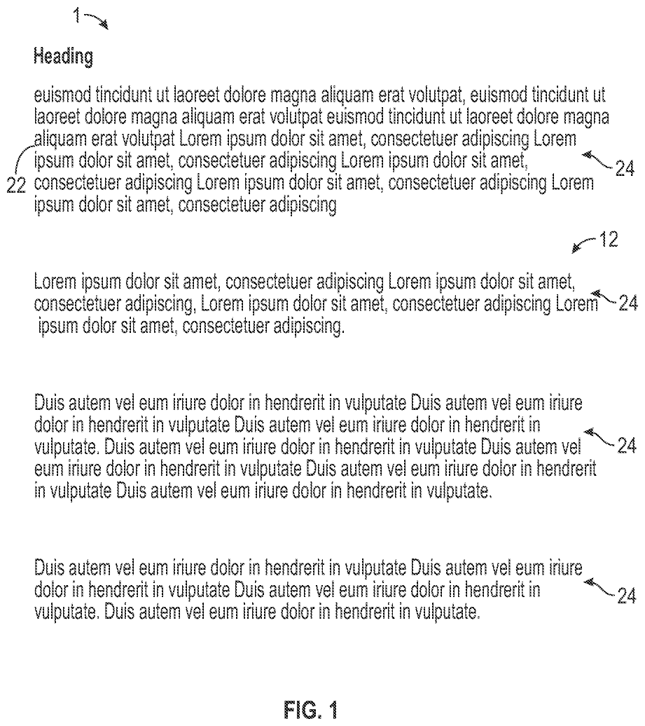

An exemplary embodiment of a computer-implemented system 1 for generating advertisements is shown in FIGS. 1-4. Generally, the system 1 inserts advertising symbols 10 in media pages 12. Media could be electronic or non-electronic, typed, printed, written, of any type now known or heretofore discovered, including but not limited to, newspapers, magazines, publications, movies, internet documents, web sites, web applications, software, mobile software, or any other textual and/or graphical material. The system 1 may perform its functions via several modules such as, e.g., a division module 14, a conversion module 15, and an insertion module 18, which may be contained in or in communication with an artificial intelligence (AI) unit 20 that performs the essential steps.

FIG. 1 shows an example of content 22 on a media page 12 before insertion of advertising symbols by the system. In this example, the content is presented in .DOC format. This illustrates an exemplary basic form that can represent a part of an electronic document like an internet web site, computer program, mobile software application, or a page of any type of media like a newspaper, magazine or any other publication.

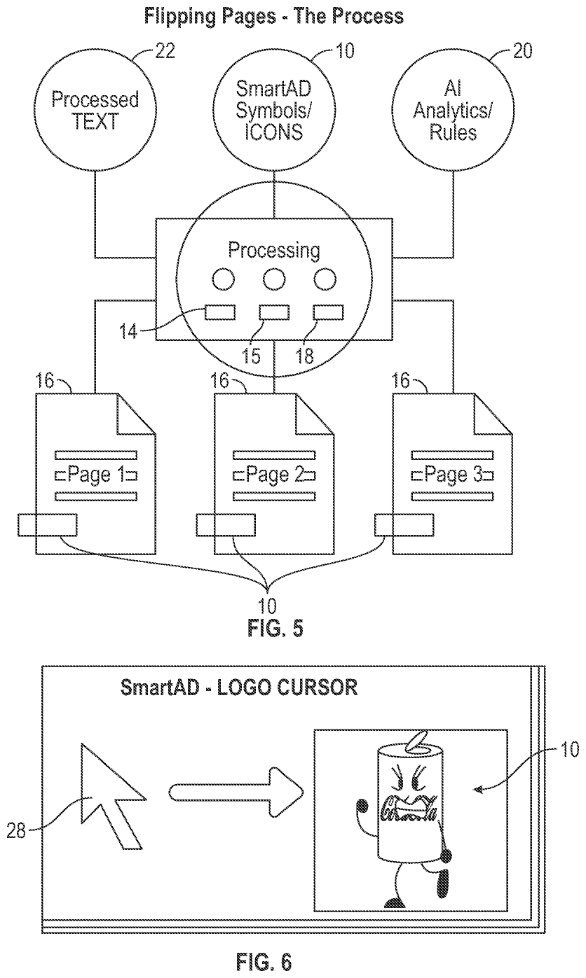

In exemplary embodiments, division module 11 divides the content 22 displayed on a media page 12 into several discrete sets 24 of content, which may be organized sequentially. The conversion module 15 then distributes the discrete sets 24 of content among one or more flipping pages 16 of browsable media accessible by a reader from the original media page 12, as best seen in FIG. 5. Advantageously, the number of flipping pages 16 may be greater than what are simultaneously displayed on a single display. Insertion module 18 inserts an advertising symbol 10 (or multiple symbols) into one or more locations 26 within the flipping pages 16. The advertising symbols 10 can be dynamically inserted at any advertising location 26 within the flipping pages 16 to form a flipping page with an embedded advertisement. In exemplary embodiments, the advertising symbols 10 are inserted between two of the flipping pages 16.

The advertisement locations could comprise at least one of a single page and/or multiple pages and could be full-page, multiple full-page, or nearly full-page advertising symbols 10 in between pages or paragraphs of the media. In exemplary embodiments, the advertisement length is tailored based on the discrete sets 24 of content. For example, the advertisement may be configured to have a length equal to, longer than, or shorter than the length of a discrete set 24 of content. The advertisement also could be configured to have a length equal to some multiple of lengths of discrete sets 24 of content.

The advertising symbols 10 could be embedded among the pages or paragraphs that belong to a single electronic or non-electronic document or to a web site being browsed using an Internet browser, or between pages or paragraphs belonging to different electronic or non-electronic documents or web sites. The advertising symbols 10 may comprise a web page and/or an electronic book page. Once the advertising symbols 10 are inserted, the system 1 then displays the media page 12 with the embedded advertising symbols 10.

Advertising symbols may be inserted anywhere in the written material and may be in black and white, gray scale, or color. The advertising symbols 10 can be inserted in the content so they replace typical text or graphic characters (ASCII format or any type of image format) in the media page 12 or pages. For example, an advertising symbol 10 could replace a letter, word, or phrase in the media text. Advertising symbols 10 could also be inserted instead of punctation marks such as periods (dots), commas, question marks, and exclamation points, or any other textual or graphical content. Thus, disclosed systems and methods significantly increase the volume of material advertised, providing increased exposure to readers/browsers.

An advertising symbol 10 could be any type of marketing or branding item, including any trademark or service mark of an advertiser. For example, it may be the advertiser's corporate name or logo, product name or logo, symbol, any brand name, or any other type of advertisement material. In exemplary embodiments, the advertising symbol 10 is a corporate logo or product logo in a flipping page 16 having the embedded advertisement within the media content. In the event of replacement of punctuation marks, the advertising symbol might be a miniaturized logo. To provide additional benefit to advertisers, an advertising symbol 10 in internet media could be linked to a corporate web site or other site to purchase the product being advertised. Advantageously, the user can define text or graphics characters to be automatically replaced with an advertising symbol.

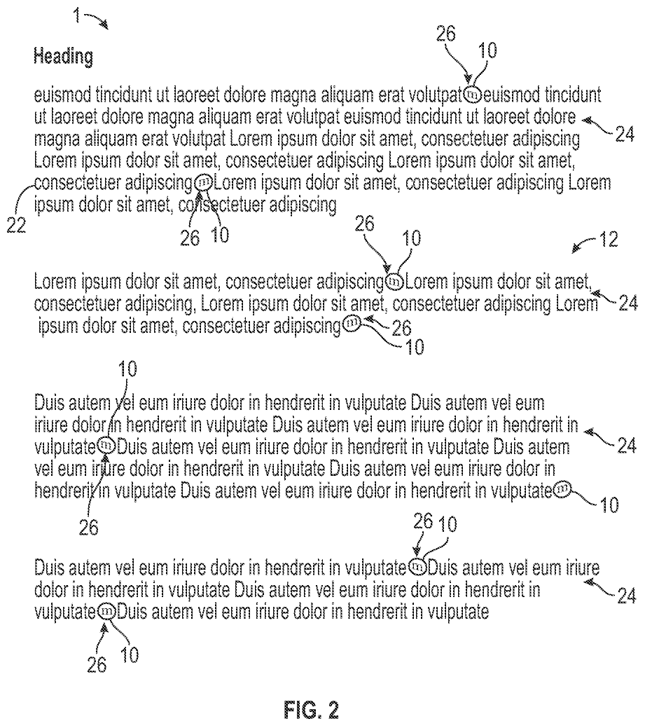

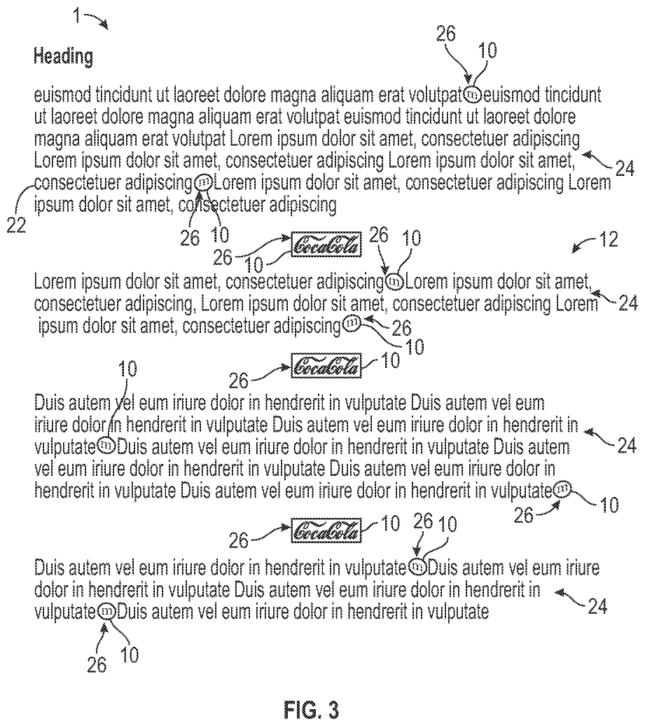

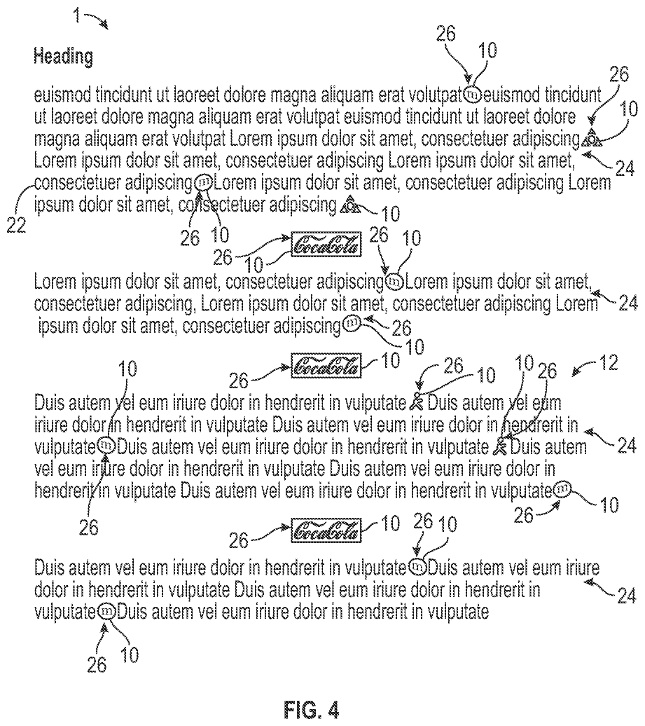

FIGS. 2-4 provide examples of a media page 12 having content 22 with embedded advertising symbols 10. This figure shows the same document as in FIG. 1 with the replacement of a period (dot) with an advertising symbol 10. The advertising symbol 10 represents M&M's® candy and, in this example, replaces every period. In the same manner, every desired character may be replaced by any advertising symbol 10. In every location 26 that a period was typed in the original document an advertising symbol 10 is now shown. In this example, each period is replaced with the M&M's® logo. In FIG. 3, the same media page 12 is illustrated with advertising symbols 10 inserted between the paragraphs in addition to replacing periods. The advertising symbols 10 in this example are of the Coca Cola® Company. FIG. 4 shows advertising symbols 10 placed between the sentences in addition to replacing periods. The symbols in this example are of the AOL® Company.

Turning to FIGS. 6-8, in exemplary embodiments an advertising symbol 10 can replace the mouse cursor 28. This could mean the cursor becomes a company's logo, company's name, advertisement icon, other advertising symbol, or web link. The mouse cursor 28 could become a company or web site theme logo as the user visits the company web site. Exemplary embodiments also provide for the mouse cursor 28 to become a hand icon 29 when it hovers above a link on the web site and return to being the advertising symbol 10 when moved away from the link. Alternatively, if the mouse cursor 28 is hovering over a link to the advertiser's web site, the cursor becomes the advertising symbol 10, e.g., the advertiser's logo.

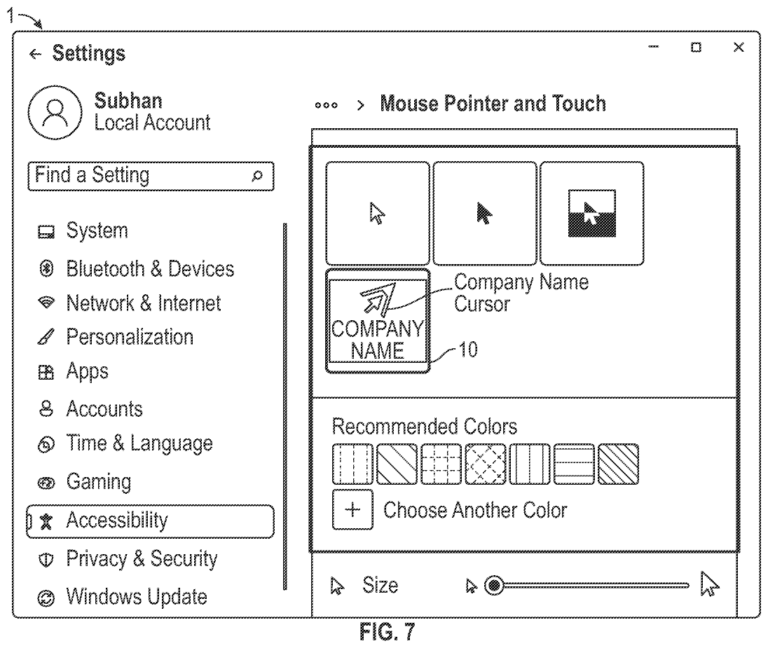

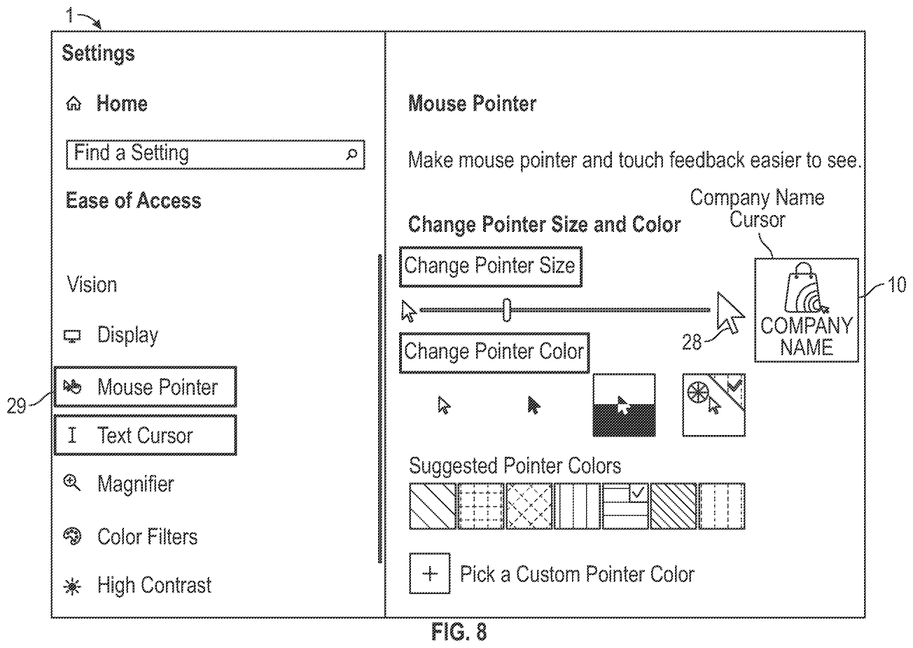

For example, if the user hovers the mouse cursor 28 over a web site link to the Nike® web site, the cursor 28 becomes the Nike® swoosh logo. Upon entering the Nike® web site, the cursor becomes the swoosh logo as well. In the case of a mobile smartphone application, since here there is no cursor, the company's logo may be implemented within punctuation marks like commas, periods, exclamation points, and questions marks in text that is visible on the smartphone. FIGS. 7 and 8 illustrate exemplary embodiments of the system 1 with user interfaces for enabling and implementing the mouse cursor functionality.

As mentioned above, exemplary embodiments include an AI unit 20 with a recurrent neural network (RNN) 64 which performs some of the key functions of the system 1. The division module 14, conversion module 15, and insertion module 18 may be part of the AI unit 20. AI unit 20 may scan a given text, identifying key words and either implanting advertising symbols 10 in any location related to the key words (nearby or any reasonable location that is selected by the AI) or replacing these key words with the advertising symbol 10. For example, the AI unit 20 might identify the word Nike® within a text paragraph and place the swoosh logo immediately after it or replace the word Nike® with the swoosh logo. The AI unit could identify the text and key words in NLP (Natural Language Processing) way.

Advantageously, exemplary systems 1 are compatible with all standard programs and work with all standard text and graphics documents formats. Thus, advertising symbols 10 can be inserted and embedded within MS Windows, Linux, and UNIX software programs and within any mobile software applications, including but not limited to the mobile software applications of Apple iOS, Apple Watch iOS, and Android. The advertising symbols 10 can be stored on any integrated circuit memory as permanent and/or portable memory like ROM, RAM, and Flash memory. Formats may be .DOC (MICROSOFT WORD), .TXT. RTF, X ML or .HTML. Exemplary systems and methods are privacy-ensured so that a user's identity is not compromised.

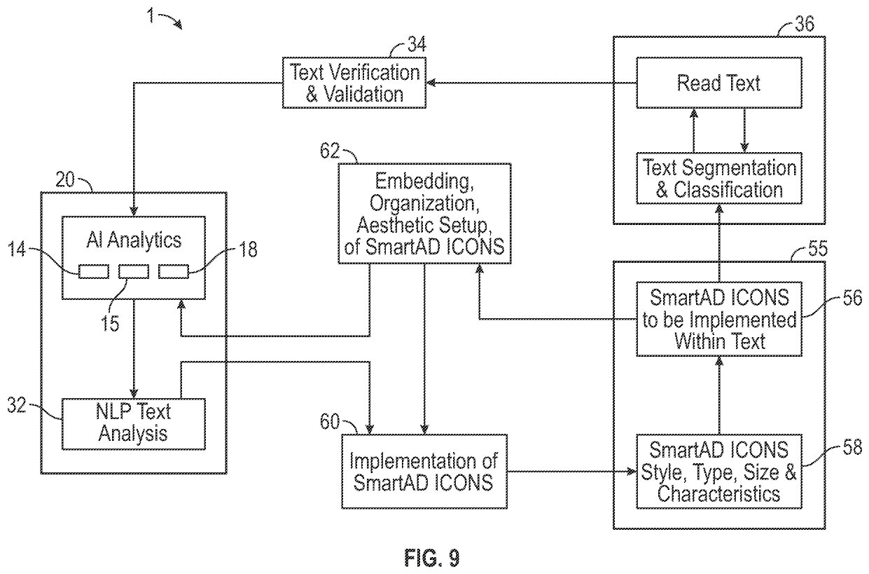

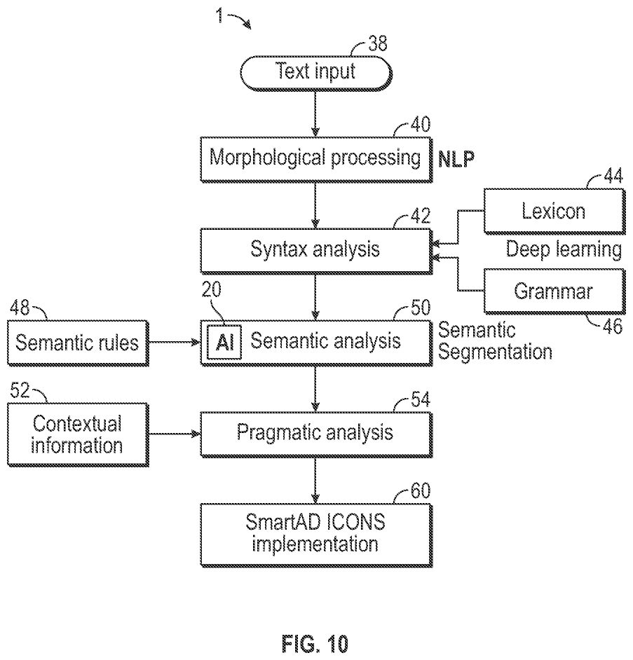

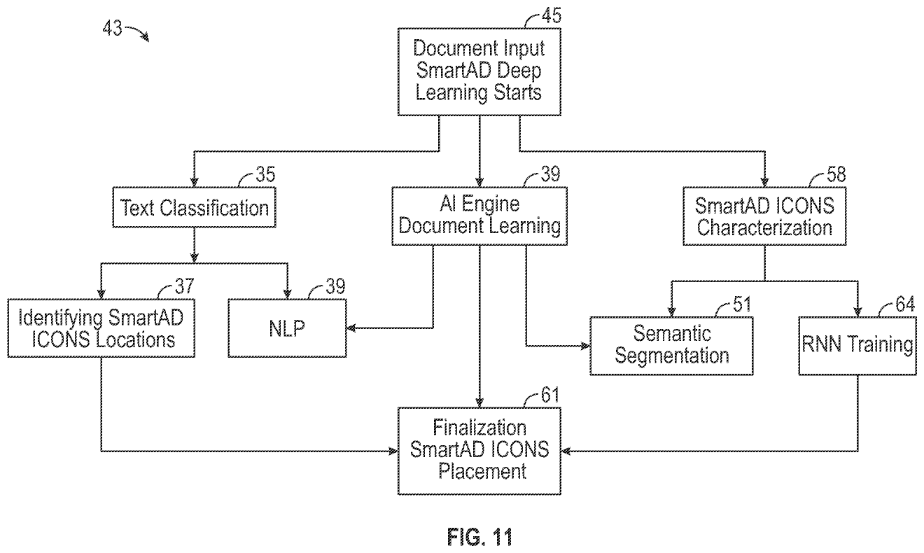

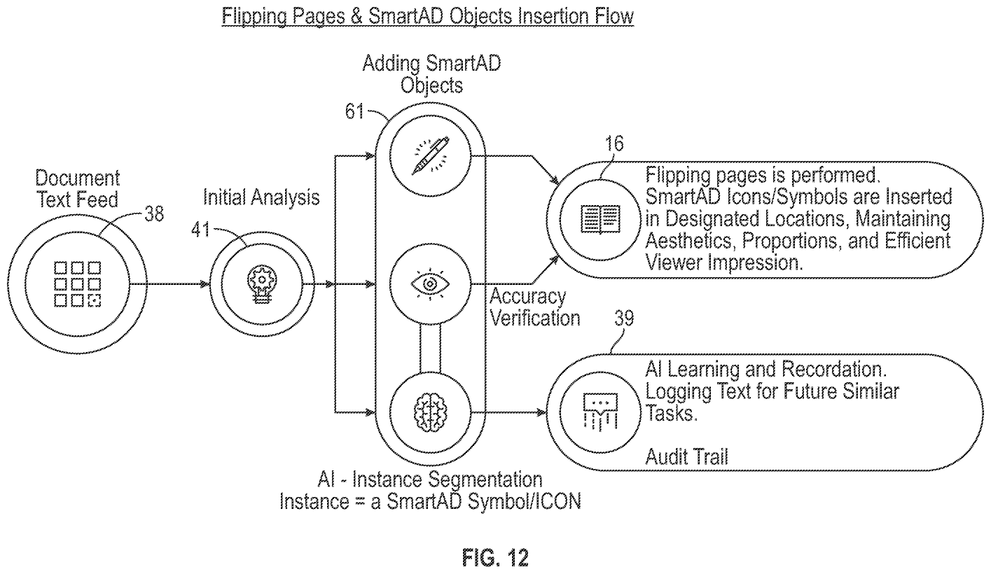

In operation, the content on a media page 12 is scanned and divided into discrete sets 24 of content. The high-level system operation is shown in FIG. 9, and exemplary content processing (text flow) is illustrated in FIG. 10. FIG. 11 shows an exemplary AI deep learning process flow 43, and FIG. 12 illustrates the flipping pages and advertisement insertion flow. In exemplary processes, text input 38 or document input 45 starts the deep learning process, which advantageously involves document learning 39 by the AI unit 20. Scanning may include NLP text analysis 32 and text verification and validation 34.

In exemplary embodiments, dividing the content involves text classification 35 and segmentation 36. Exemplary processes start with text input 38 and NLP analysis 39 such as morphological processing 40 of the text. Next, the system 1 performs its initial analysis 41, which may include syntax analysis 42, a deep learning process 43 that may include learning both lexicon 44 and grammar 46. Semantic rules 48 may be input to the AI unit 20 so it can perform semantic analysis 50 including semantic segmentation 51. Based on contextual information 52 fed into the system 1, a pragmatic analysis 54 may also be performed. Some or all of the steps in these processes are accompanied by RNN training 64.

The sets 24 of content are then converted into flipping pages 16 that a reader can access from the media page 12. The system identifies 37 locations for the advertising symbols 10. One or more advertising symbols 10 are selected 55, including determining 56 which advertising symbols are to be implemented within the text and selecting their characteristics 58 such as style, type, and size. The advertising symbols 10 are then implemented 60, assigned to locations in the flipping pages 16 and, in the finalization and placement stage 61, inserted/embedded 62 into the assigned locations 26. The advertising symbols 10 may be selected based on a pre-determined relevance between the advertisement and the content. The flipping page or pages 16 that have the embedded advertising symbol or symbols 10 may then be displayed in a form of browsable media. The selecting step could be performed at the same time as the displaying step. The content and advertisement could be stored together as one unit.

Various steps could be performed to increase the likelihood that the reader will see the advertising. For example, one or more portions of the content could be reorganized around one or more of the advertising symbols 10. The content with the advertising symbols 10 also could be advanced to a selected position within the electronic media and web page presentation. A particular advertising symbol could be bookmarked as well. To reach wider audiences, advertising symbols 10 could inserted in theater, cinema, and/or television credits. The advertising symbols 10 could appear within the movie title, sub-title, scrolling credits or any other type of document.

Exemplary embodiments take the sequential text and/or graphical display of content in browsable electronic or non-electronic media with one or more flipping pages 16 and divide the content into at least two discrete sets 24 of content simultaneously displayed on a single display. The content could be from any number of different web pages. An indicator of a position of the two displayed discrete sets 24 of content may be placed within the content. The advertisement (first advertising symbol 10) may make up the entirety of one or both sets 24 of content. Alternatively, a second, different advertising symbol 10 could be inserted in the second set 24 of content and make up the entirety of the second set 24 of content. The first and second advertising symbols 10 might originate from the same advertiser or two different advertisers.

As mentioned above, advertising symbols 10 may be selected based on a pre-determined relevance between the advertisement and the content. Users of the system 1 such as authors or other content providers can specify the kind of advertisements they are looking for and other parameters of the advertisements so that the system identifies the relevant advertisements to be incorporated into the electronic books or other content hosted on some web sites. Similarly, advertisers can specify the kind of advertisements they are offering (as well as other parameters of the advertisements) so that the system 1 can identify the relevant advertisements to be offered to electronic book authors or other content providers. Advantageously, the system 1 automatically matches advertisement requests and advertisement offers resident in a database.

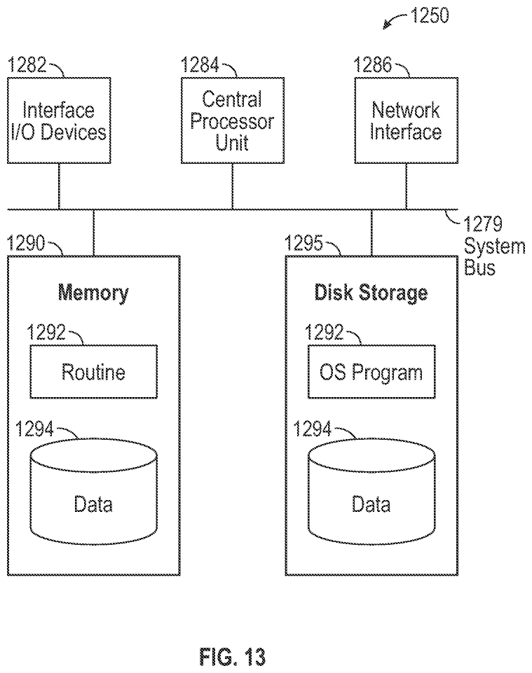

FIG. 13 shows an exemplary internal structure of a computer 1250 in which various embodiments of the present disclosure may be implemented. The computer 1250 contains a system bus 1279, where a bus is a set of hardware lines used for data transfer among the components of a computer or processing system. Bus 1279 is essentially a shared conduit that connects different elements of a computer system (e.g., processor, disk storage, memory, input/output ports, network ports, etc.) that enables the transfer of information between the elements. Attached to system bus 1279 is I/O device interface 1282 for connecting various input and output devices (e.g., sensors, transducers, keyboard, mouse, displays, printers, speakers, etc.) to the computer 1250. Network interface 1286 allows the computer 1250 to connect to various other devices attached to a network.

Memory 1090 provides volatile storage for computer software instructions 1292 (e.g., instructions for the processes/calculations described above and data 1294 used to implement embodiments of the present disclosure). Disk storage 1295 provides non-volatile storage for computer software instructions 1292 and data 1294 used to implement embodiments of the present disclosure. Central processor unit 1284 also is attached to system bus 1279 and provides for the execution of computer instructions.

In an exemplary embodiment, the processor routines 1292 (e.g., instructions for the processes/calculations described above) and data 1094 are a computer program product (generally referenced 1292), including a computer readable medium (e.g., a removable storage medium such as one or more DVD-ROMs, CD-ROMs, diskettes, tapes, etc.) that provides at least a portion of the software instructions for exemplary embodiments. Computer program product 1292 can be installed by any suitable software installation procedure, as is well known in the art.

In another embodiment, at least a portion of the software instructions may also be downloaded over a cable, communication and/or wireless connection. Further, the present embodiments may be implemented in a variety of computer architectures. The computer of FIG. 13 is for purposes of illustration and not limitation. In some embodiments of the present disclosure, the system may function as a computer to perform aspects of the present disclosure.

Thus, it is seen that systems and methods of generating smart, unobtrusive advertisements are provided. It should be understood that any of the foregoing configurations and specialized components or connections may be used interchangeably with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A computer-implemented system of generating advertisements, comprising:
a division module dividing content displayed on a media page into a plurality of discrete sets of content;
a conversion module converting the plurality of discrete sets of content into one or more flipping pages accessible by a reader from the media page; and
an insertion module inserting one or more advertising symbols into one or more locations within the one or more flipping pages.

2. The computer-implemented system of claim 1 wherein the one or more advertising symbols replace text or graphic characters in the plurality of discrete sets of content.

3. The computer-implemented system of claim 1 wherein the text or graphic characters replaced by the one or more advertising symbols are punctuation marks.

4. The computer-implemented system of claim 1 wherein the one or more advertising symbols replace a mouse cursor.

5. The computer-implemented system of claim 1 wherein the one or more flipping pages comprise at least two sequential flipping pages, and the insertion module inserts the one or more advertising symbols between two of the at least two sequential flipping pages.

6. The computer-implemented system of claim 1 wherein the media page is an electronic media page or a print media page.

7. The computer-implemented system of claim 1 wherein the one or more advertising symbols comprise one or more of: a corporate logo, a product logo, or a brand name.

8. The computer-implemented system of claim 1 further comprising an artificial intelligence unit;
wherein the division module, the conversion module, and the insertion module are contained in or in communication with the artificial intelligence unit.

9. The computer-implemented system of claim 8 wherein the artificial intelligence unit scans the content in the media page, identifies pre-defined words, and assigns the one or more advertising symbols to the one or more locations in the one or more flipping pages.

10. A computer-implemented method of generating advertisements, comprising:
scanning content displayed on a media page;
dividing the content into a plurality of discrete sets of content;
converting the plurality of discrete sets of content into one or more flipping pages accessible by a reader from the media page;
assigning one or more advertising symbols to one or more locations in the one or more flipping pages; and
inserting one or more advertising symbols into the one or more assigned locations within the flipping pages.

11. The computer-implemented method of claim 10 further comprising displaying the one or more flipping pages having the one or more advertising symbols.

12. The computer-implemented method of claim 10 further comprising bookmarking one of the one or more advertising symbols.

13. The computer-implemented method of claim 10 further comprising assigning the one or more advertising symbols based on pre-determined relevance criteria.

14. The computer-implemented method of claim 10 further comprising simultaneously displaying at least two discrete sets of content on a single display.

15. The computer-implemented method of claim 14 wherein the one or more advertising symbols in a first of the at least two discrete sets of content comprise a first advertising symbol or relate to a first advertiser.

16. The computer-implemented method of claim 15 wherein the one or more advertising symbols in a second of the at least two discrete sets of content comprise a second advertising symbol or relate to a second advertiser.

17. The computer-implemented method of claim 10 wherein the content comprises credits of a show, a series, or a movie.

18. The computer-implemented method of claim 10 wherein the advertising symbols are inserted using an industry standard text and graphics document format.

19. The computer-implemented method of claim 10 wherein at least some of the method steps are performed using artificial intelligence.

20. The computer-implemented method of claim 19 wherein the one or more flipping pages comprise at least two sequential flipping pages, and the inserting step comprises inserting the one or more advertising symbols between two of the at least two sequential flipping pages.
